(19) United States
(12) Patent Application Publication
(10) Pub. No.: US 2002/0095353 A1
(43) Pub. Date: Jul. 18, 2002

(54) System for preventing unauthorized access to products in retail system

(76) Inventor: Sergey N. Razumov, Moscow (RU)

Correspondence Address: McDERMOTT, WILL & EMERY, 600 13th Street, N.W., Washington, DC, 20005-3096, US

(21) Appl. No.: 10/046,309

(22) Filed: Jan. 16, 2002

Related U.S. Application Data
(63) Continuation-in-part of application No. 09/745,420, filed on Dec. 26, 2000.

(51) Int. Cl. G06F 17/60

(52) U.S. Cl. 705/26

(57) ABSTRACT

A novel system for preventing unauthorized access to products is provided in a retail system in order to prevent exposure of the products to contamination caused by bioterrorism. The system for preventing unauthorized access comprises an order-processing system for receiving a purchase order from a customer, and a tracking system for tracking the ordered product until the product is received by the customer. In particular, the system for preventing unauthorized access is suitable for preventing exposure of food products handled in a retail system to contamination by unwanted or dangerous substances.

### RELATED APPLICATIONS

The present application is a continuation-in-part of the U.S. patent application No. b 09/745,420 filed on Dec. 26, 2000, entitled “RETAIL SYSTEM WITH PURCHASE ORDERING” and incorporated herewith by reference.

### FIELD OF THE INVENTION

The present invention relates to retail systems, and more specifically, to prevention of unauthorized access to products in a retail system having a mechanism that enables customers to place a purchase order.

### BACKGROUND OF THE INVENTION

In the aftermath of recent events relating to terrorists' activity, there is increasing public concern over bioterrorism and its impact on the food supply. All segments of the food-related industry, including production, processing, handling, distribution and retail sectors, as well as suppliers to the industry such as companies supplying packaging materials, chemicals, etc. are affected by the increased threat.

Hence, there exists a need for a way to reduce a risk of exposure products, and especially, food products in a retail system to contamination by unwanted or dangerous substances.

### SUMMARY OF THE INVENTION

The present application provides a novel system for preventing unauthorized access to products in a retail system in order to prevent exposure of the products to contamination caused by bioterrorism.

The system for preventing unauthorized access comprises an order-processing system for receiving a purchase order from a customer, and a tracking system for tracking the ordered product until the product is received by the customer. In particular, the system for preventing unauthorized access of the present invention is suitable for preventing food products handled in a retail system from being exposed to contamination caused by bioterrorist activity.

In accordance with one aspect of the invention, at least one separate package is provided for packing the product ordered by the customer. The package may be sealed to prevent exposure of the product to contamination. The tracking system may record information indicating location of the package until the customer receives the ordered product, to prevent the package from being placed in an unauthorized location. A misplacement alarm mechanism may be provided for indicating that the package is located outside of a predetermined route from a package packing location to a destination location requested by the customer.

In accordance with another aspect of the invention, the tracking system may record information on every person handling the package to prevent unauthorized access to the package. A personnel verification mechanism may be provided for determining whether the package is being accessed by an authorized person. An unauthorized access alarm mechanism may be arranged to indicate that an unauthorized person has access to the package.

The purchase order placed by a customer may be transferred to a storage facility for preparing the package with the ordered product. An ID information relating to the package prepared on the storage facility may be entered into the tracking system. For example, the ID information may identify the customer that ordered the product contained in the package, and a destination for delivery of the package.

The tracking system may maintain a package address data stream indicating changes in location of the package formed in the storage facility until the packet is received by the customer.

A transportation unit, such as a car, truck or van, is used for delivering the package from the storage facility to a destination requested by the customer In accordance with a further aspect of the invention, the tracking system may record transportation information for the package to identify a transportation unit used for delivery of the package. A transportation verification mechanism may be provided for determining whether the package is being delivered by an authorized transportation unit.

In accordance with another aspect of the present invention, the retail system includes multiple retail facilities that enable customers to obtain products ordered in advance. Each retail facility may include multiple purchase pick-up points for enabling the customers to receive and inspect ordered products.

In accordance with a further aspect of the invention, an access control system may be provided for controlling access to the retail facility. The access control system may identify customers entering the retail facility to ensure that only people that placed an order for a purchase are allowed to access the retail facility.

In accordance with another aspect of the invention, the number of people in the retail facility is minimized by assigning a particular purchase pick-up point to each customer. Only after a purchase pick-up point is assigned to a customer, the access control system enables that customer to access the retail facility.

In accordance with a further aspect of the present invention, a customer is prevented from accessing a product ordered by another customer. A package containing a product ordered by a customer is delivered to the purchase pick-up point assigned to that customer.

The tracking system may record information indicating that the package is delivered to a purchase pick-up point assigned to the customer that ordered the product contained in the package. In particular, the address information of the package in the tracking system may be updated when the package is placed on a storage cart for delivery the package from the storage area to the assigned purchase pick-up point, and when the package is removed from the storage cart and placed at the assigned pick-up point.

The retail facility may be provided with a video monitoring system comprising a plurality of video cameras for recording video data relating to handling packages.

In accordance with another aspect of the invention, the tracking system comprises video synchronizing system that synchronizes package tracking data recorded by the tracking system with the video data produced by the video monitoring system.

In particular, the video synchronizing system may create association between the package tracking data recorded during a particular time frame and the video data recorded during that time frame.

Also, the video synchronizing system may create association between location of a video camera that records the video data and location of the package identified by the package tracking data recorded by the tracking system.

For example, a video camera may be assigned to each purchase pick-up point. The video synchronizing system may provide association between the package tracking data relating to a package delivered to a purchase pick-up point assigned to a customer that ordered a product contained in the package, and the video data recorded by the video camera assigned to that purchase pick-up point.

In accordance with a further aspect of the invention, the purchase pick-up point may enable a customer to receive a pre-ordered product without leaving a vehicle.

In accordance with one aspect of the present invention, the following steps are carried out for selling goods:

enabling a customer to order a product in advance,

forming a package including the ordered product, and

tracking the package until the product is received by the customer to prevent unauthorized access to the product.

In accordance with another aspect of the present invention, multiple purchase pick-up points are provided for enabling customers to receive the goods. Information identifying the goods to be received by the customers is recorded, together with video data produced by monitoring the purchase pick-up points. Association is provided between the recorded information on a product received at a purchase pick-up point, and the video data relating to that purchase pick-up point.

Still other aspects and advantages of the present invention will become readily apparent from the following detailed description, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 illustrates a retail system of the present invention.

FIG. 2 illustrates an exemplary embodiment of a tracking system in the retail system of the present invention.

FIG. 3 illustrates an exemplary embodiment of a retail facility of the present invention.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and entities are shown in block diagram form in order to avoid unnecessarily obscuring the present invention.

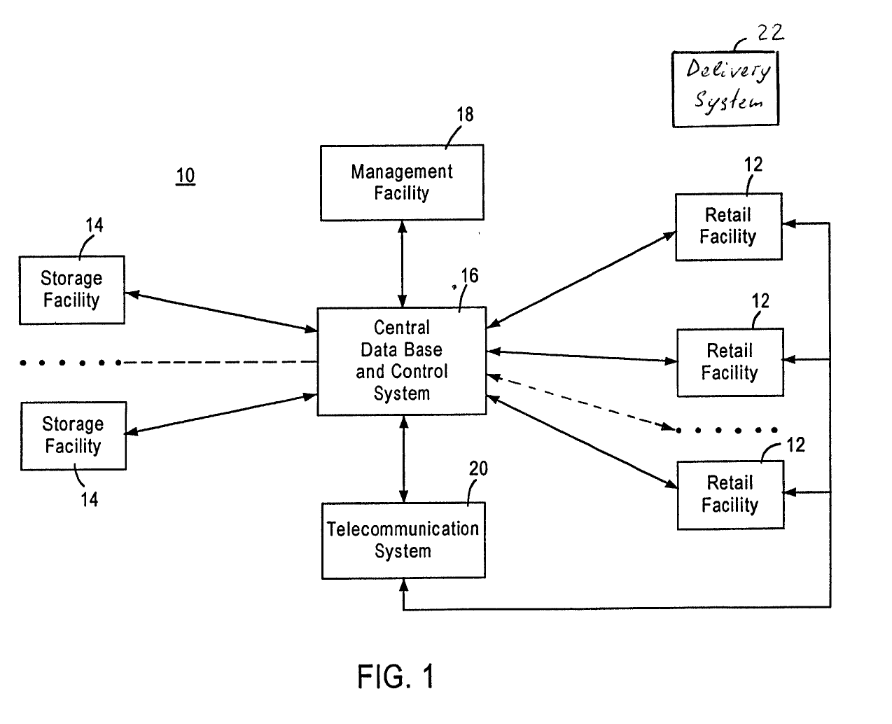

As schematically illustrated in FIG. 1, a retail system 10 of the present invention may comprise a plurality of retail facilities 12 for enabling customers to order and/or receive purchases, a plurality of storage facilities 14, a central data base and control system 16, a management facility 18, and a telecommunications system 20, such as an Internet-based communications network. A delivery system 22 may be provided to enable delivery of goods to the storage facilities 14, and from the storage facilities 14 to the retail facilities 12. For example, the retail system 10 of the present invention may sell such items as food products, consumer goods, video/audio products, books, clothing, etc.

Each retail facility 12 may be a purchase ordering facility that enables a customer to place an order for a purchase, or a purchase check-out facility that provides the check-out of the purchase ordered by the customer. Also, the purchase ordering facility may be combined with the check-out facility.

Alternatively, as disclosed in more detail below, an order for a purchase may be placed from a location remote with respect to the retail facility 12, such as a customer's place of residence or business, using a telecommunications network such as the Internet, or a regular telephone system.

In accordance with the present invention, a location for placing an order for a purchase is independent from the location where the ordered purchase may be checked out and picked up. While a customer may place an order and receive the ordered purchase at the same retail facility 12, the customer is enabled to order a purchase at one retail facility 12, and receive the ordered purchase at another retail facility 12. For example, a customer may place a purchase order at the retail facility 12 located near the customer's place of business, and receive the ordered purchase at the retail facility 12 located near the customer's residence.

The storage facilities 14 are provided for storing goods that may be ordered by customers. Also, the storage facilities 14 may provide collecting and packing goods to prepare packages containing ordered purchases.

In accordance with one aspect of the present invention, each purchase ordered by a particular customer is packed on the storage facility 14 into one or several packages designated for that customer. A separate package or a separate group of packages is provided for each purchase order. No goods for more than one customer are placed in the same package. For example, a plastic box or basket may be used as the package. Unpacked food products, such as fruits and vegetables, may be packed before placing them into the package.

When goods are placed into a package, the package may be sealed to prevent exposure of the goods to contamination. Each package has a label with identification (ID) information that may identify the package and indicate the contents of the package, the customer to whom it should be delivered, delivery instructions identifying a destination for delivery of the package, and other information. Also, the ID information on the package may identify all storage facility's personnel that handled goods included in the package, for example, an operator that packed the goods, and an operator that packed and sealed the package. The ID information may be presented in a code, such as a bar code, readable by a code reading device, such as an optical scanner, or any other optical, electrical or magnetic data detector.

Each storage facility 14 may be provided with a security mechanism for preventing unauthorized people from entering the storage facility. For example, the storage facilities may contain identification systems capable of identifying authorized personnel based on predetermined identification criteria.

The delivery system 22 provides delivery of the packages to retail facilities 12, or to any other location chosen by the customer. The delivery system 22 may include a number of transportation units, such as tracks or other vehicles, for transporting the packages to a required destination.

A group of packages destined for the same retail facility 12 or for the same location selected by the customer may be carried in a container. Alternatively, a container may be used instead of a package for carrying goods ordered by a particular customer.

The transportation unit may be loaded with a number of containers destined for the same retail facility 12 or for locations in the same area. To prevent unauthorized access to packages in a container, each container may be sealed before loading to the transportation unit. Each container may have a label with ID information that may identify the container and include delivery instructions, including a destination for delivery of the container, and other information. The container's ID information may be presented as a code readable by a code reading device. If a container is used instead of a package, the container may be identified with ID information described above in connection with the package. To prevent unauthorized access to a transportation unit, each transportation unit may be sealed before leaving the storage facility 14. A security mechanism may be provided to prevent unauthorized access to the transportation unit.

One storage facility 14 may be provided in a particular area to supply the retail facilities 12 arranged in that area with the ordered purchases. A purchase order received from a customer may be transferred to the storage facility 14 designated to supply the retail facility 12 or other location selected by the customer for picking up the purchase.

In response to the purchase order, the designated storage facility 14 provides collecting goods ordered by the customer and packing these goods in one or more packages to be delivered to the retail facility 12 or other location selected by the customer. A time interval between placing an order for a purchase and picking up the ordered purchase should be sufficient to deliver the purchase from the corresponding storage facility 14 to the retail facility 12 or other location selected by the customer.

The central data base and control system 16 performs collection, storage and processing of data required to support operations of the retail system 10. Also, the central data base and control system 16 supports interactions between various elements of the retail system 10. For example, the central data base and control system 16 may provide the storage facilities 14 with purchase order information in response to purchase order requests from customers.

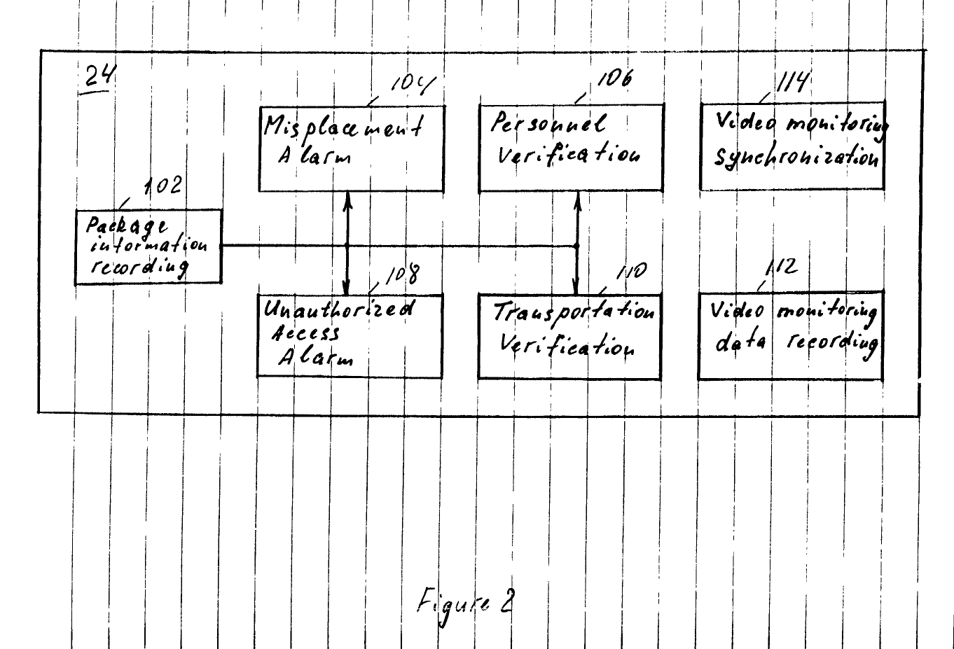

As described in more detail later, the central data base and control system 16 includes a tracking system 24 (FIG. 2) for tracking a product ordered by a customer from the moment the product is packed at the respective storage facility 14 until the moment the ordered product is received by the customer. The tracking system 24 prevents unauthorized access to the product to guarantee that the product is not exposed to contamination by unwanted or dangerous substances due to terrorist's activity.

The management facility 18 performs management and administrative functions required to support operations of the retail system 10. In particular, an operator at the management facility 18 may supervise operations relating to preventing unauthorized access to products in the retail system 10. When the tracking system 24 detects an event indicating the possibility of unauthorized access to products, an operator at the management facility 18 may carry out appropriate security measures to eliminate or minimize the damage caused by the unauthorized access.

In addition, the management facility 18 may monitor retail system operations to detect and correct errors and malfunctions. Also, the management facility 18 may be responsible for maintaining adequate amount of goods at the storage facilities 12, collecting and analyzing sales information, marketing, and establishing prices.

The telecommunications system 20 enables customers to place purchase orders from locations remote with respect to the retail system facilities. In particular, the retail facilities 12 of the present invention may provide the checkout of purchases ordered via the Internet or a telephone system. The telecommunications system 20 may support the customer's access to the central data base and control system 16 to receive information on product availability and prices.

To facilitate the ordering process, the customer may be provided with a data storage device, such as a CD-ROM or DVD device, which contains information on items available in the retail system 10. The telecommunications system 20 may connect the customer's data storage device to the central data base and control system 16 to update the information stored by the data storage device.

The telecommunications system 20 transmits information on a purchase order placed by a customer to the central data base and control system 16 for arranging purchase delivery from the respective storage facility 14 to the retail facility 12 or other location selected by the customer.

In an alternative embodiment of the invention, the telecommunications system 20 supports placing an order via a telephone system. In this case, a customer can place a telephone call to an operator to order a purchase composed of items selected based on the information provided by the operator or using a list of available items. The present invention enables the customer that made a telephone purchase order to receive the ordered purchase at any retail facility 12 or any other location selected by the customer.

As schematically illustrated in FIG. 2, the tracking system 24 includes a number of mechanisms that enable a product ordered by a customer to be tracked from the moment the product is packed at the respective storage facility 14 to the moment the ordered product is received by the customer, in order to prevent unauthorized access to the product and eliminate exposure of the product to contamination by unwanted or dangerous substances due to terrorist's activity.

In particular, the tracking system 24 includes a package information recording mechanism 102 for recording information identifying a package that contains a product ordered by a customer and indicating status and/or location of the package until the package is received by the customer. As a result, the tracking system is enabled to track status and location of each package. A misplacement alarm 104 may be provided to indicate that a package is located outside of a predetermined route selected for delivery the package from the storage facility to a destination selected by a customer.

Also, the recording mechanism 102 may record information identifying any person involved in handling a package. For example, the recording mechanism 102 may enter the information identifying personnel that packs the package at the storage facility 14, loads the package into a container, loads the container to a transportation unit used for delivery of the package, unloads the container from the transportation unit and handles the package in the retail facility 12.

The central data base and control system 16 may supply the tracking system 24 with information identifying personnel authorized to perform operations in connection with handling packages. A personal verification mechanism 106 may be provided to determine whether a package is handled by an authorized person. An unauthorized access alarm 108 may indicate that an unauthorized person has access to a package.

When a package containing an ordered product is formed at the storage facility 14, the recording mechanism 102 enters into the tracking system 24 the ID information that identifies the package and may indicate the contents of the package, the customer to whom it should be delivered, delivery instructions identifying a destination for delivery of the package, and other information.

When the package is placed into a container for delivery to the retail facility 12 or other location selected by the customer, the recording mechanism 102 records the ID information of the container in association with the ID information of the package to make it possible to determine which container carries the package being tracked.

When the container with the package is loaded into a transportation unit, such as a truck, van or car, for transporting the ordered product to the retail facility 12 or other location selected by the customer, the recording mechanism 102 records ID data identifying the transportation unit in association with the ID information of the container. As a result, the tracking system 24 may determine which transportation unit carries a particular container. The central data base and control system 16 may supply the tracking system with information on transportation units authorized to deliver packages. A transportation verification mechanism 110 that determines whether a package is being delivered by an authorized transportation unit may be provided to ensure that the package is not placed into an unauthorized transportation unit.

Further, transportation units for transporting packages to the retail facility 12 or other location selected by the customer may be provided with a security system for preventing unauthorized access to products carried in the transportation units.

When the container is unloaded from the transportation unit into the retail facility 12 or at other location selected by the customer, the recording mechanism 102 enables ID information identifying a particular retail facility or a particular location to be entered into the tracking system 24 in association with the ID information of the container. Hence, the tracking system 24 stores information as to which retail facility 12 receives a particular container, or at which location the particular container is delivered.

The tracking system 24 may keep a package address data stream representing a location of each package. The package address data stream indicates changes in locations of the package from the moment when the package is formed in the storage facility 14 until the moment when the package is received by the customer.

The information recorded by the recording mechanism 102 may be entered into the tracking system 24 automatically using scanning stations arranged at predetermined locations in the storage facilities 14 and retail facilities 12 to automatically read ID information from packages and containers passing the scanning stations.

Also, the recording mechanism 102 may record information manually entered using data processing devices, such as terminals, and personal digital assistants (PDAa). Further, the information may be entered by hand-held optical, magnetic or electrical detectors, such as a scanning device, carried by operators performing particular operations in connection with handling the packages.

As described in more detail later, the recording mechanism 102 also enables the tracking system 24 to enter information indicating the status and movements of the package inside the retail facility 12 until the package is received by the customer.

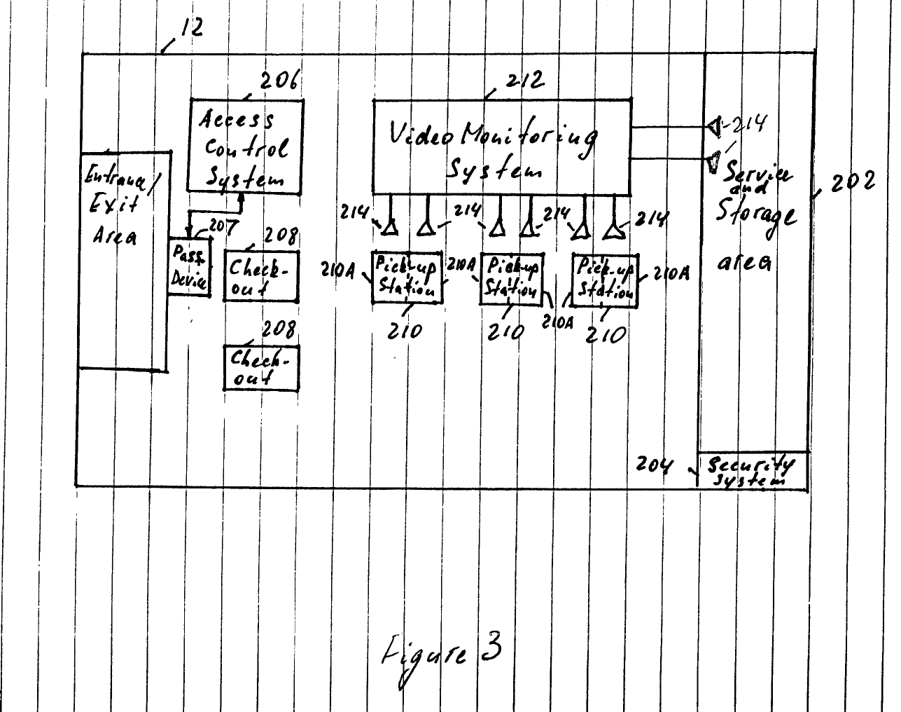

For example, as schematically shown in FIG. 3, the retail facility 12 may contain a service and storage area 202 for holding delivered packages until they are received by customers. A package unloaded from the transportation unit is placed into the service and storage area 202. The recording mechanism 102 records information indicating that a particular package is being placed into the service and storage area of a particular retail facility 12.

The service and storage area 202 may be provided with a security system 204 for preventing unauthorized access to the service and storage area 202. For example, the security system 204 may include an identification system capable of identifying authorized personnel based on predetermined identification criteria.

The retail facility 12 may comprise an access control system 206 arranged near an entrance/exit area to control customer's access to the retail facility 12 and customer's exit from the retail facility 12. Check-out stations 208 may be arranged near the exit to enable customers to pay for their purchases.

Also, multiple purchase pick-up stations 210 may be provided to enable customers to pick up and inspect their pre-ordered purchases, and confirm that contents of the order is acceptable. Each purchase pick-up station 210 may include multiple purchase pick-up sections 210A arranged so as to accommodate a single customer.

If a check-out facility is combined with a purchase ordering facility, multiple showcases, display racks, bins, shelves and the like may be provided in the retail facility 12 for holding and displaying samples representative of products available for ordering.

To ensure that only customers that placed an order for a purchase have access to the retail facility 12, the access control system 206 may identify each customer that enters the retail facility 12 to check out a pre-ordered purchase. If a purchase check-out facility is combined in the same room with a purchase ordering facility, the access control system may distinguish customers that enters the retail facility 12 to check out a pre-ordered purchase from customers that intend to place a purchase order.

The access control system 206 may control a passing device 207, such as a turnstile, so as to allow a customer to pass through the passing device only after the customer is identified by the access control system.

To minimize the number of people in the retail facility 12, the access control system 206 may interact with the central data base and control system 16 to assign a purchase pick-up section 210A to each customer that enters the retail facility to check out a pre-ordered purchase. Also, customer's identification provided by the access control system enables the central data base and control system 16 to issue a request for collecting a purchase pre-ordered by a customer simultaneously with assigning a purchase pick-up section to that customer. The access control system 206 may be equipped with a data communications circuit for providing data exchange with the central data base and control system 16.

When customers enter the retail facility 12 to pick up pre-ordered purchases, the access control system 206 reads their customer's cards to identify customers. Alternatively, the access control system 206 may identify a customer by reading its purchase order receipt issued during purchase ordering, or a customer may enter a purchase identification information, such as a purchase number, issued when the customer places an order for that purchase.

When a customer is identified, the access control system 206 transfers customer's ID information to the central data base and control system 16 that assigns a purchase pick-up section 210A to that customer.

When the purchase pick-up section 210A is assigned to a customer, the access control system 206 activates the passing device 207 to allow the customer to pass through it. Hence, the access control system 206 prevents any unauthorized person from entering the retail facility 12.

Simultaneously with assigning a purchase pick-up section 210A to a customer, the central data base and control system 16 issues a purchase collection request providing a sales assistant with purchase information relevant to a purchase order of that customer. For example, the purchase information for a customer may include a purchase order ID number, purchase address information identifying location of the purchase in the service and storage area 202, and the ID information of the purchase pick-up section 210A assigned to the customer.

The sales assistant may interact with the central data base and control system 16 in an interactive mode. For example, in response to a message from the central data base and control system 16 indicating the ID information of a customer's purchase, the sales assistant may use a handheld data processing device, such as a personal digital assistant (PDA), wirelessly connected to the central data base and control system 16 to establish the address information relating to that purchase, and the ID information of the purchase pick-up section 210A to which the purchase should be delivered.

A purchase for a customer may consist of packages stored in different storage sections of the service and storage area 202. For example, one package may be stored in the dry-product storage section, and other package may be stored in the freezing and refrigerating storage section. In this case, the purchase address information provided by the central data base and control system 16 includes address information sufficient to locate each item of the purchase in different storage areas.

A sales assistant collects the packages relating to an ordered purchase from different storage areas using a storage cart and delivers them to the assigned pick-up section 210A. The storage cart may have multiple sections for holding packages. Each of the sections may be identified by a unique address.

The tracking system 24 tracks the purchase collection process carried out in the retail facility 12. When the package stored in the service and storage area 202 is placed on a storage cart, the storage address of the purchase in the tracking system is changed to update its location. Also, the address information of the package is changed when it is removed from the storage cart and placed on the assigned purchase pick-up section 210A.

When the purchase is delivered to the pick-up station assigned to a particular customer, the customer is enabled to inspect the purchase. If the customer is satisfied with the ordered purchase, he or she may pay for the purchase directly at the pick-up station 210 using a customer's card or a credit card. The payment by a customer automatically releases the purchase pick-up section 210A assigned to that customer. As soon as the purchase pick-up section 210A is released by one customer, it may be assigned to another customer. Alternatively, the customer may pay for the purchase at the check-out station 208.

After the purchase pick-up process is completed, a purchase receipt is printed out at the pick-up station or at the check-out station depending on the way of payment selected by a customer. The purchase receipt may contain indicia readable by the access control system 206 to allow the customer to leave the retail facility 12 through the passing device 207.

The retail facility 12 and operations performed to support purchase pickup and check-out processes are described in more detail in my copending U.S. application Ser. No. 09/788,674 filed on Feb. 21, 2001, entitled Purchase Checkout Arrangement in Retail System, and incorporated herewith by reference.

To prevent any person allowed into the retail facility 12 from accessing a product ordered by another customer, the package information recording mechanism 102 enters into the tracking system 24 all information relating to a current status and location of a particular package in the retail facility 12 from the moment when the package is delivered to the retail facility 12 to the moment when the purchase including the package is received by a customer that ordered that purchase.

Also, the retail facility 12 contains a video monitoring system 212 including multiple video cameras 214 arranged in predetermined locations of the retail facility 12. For example, a separate video camera 214 may be assigned to each pick-up section 210A of the pick-up station 210 to record operations relating to handling a package delivered to a respective pick-up section 210A.

As a particular pick-up section 210A is assigned to a particular customer identified by the access control system 206, the video camera 214 monitoring the pick-up section 210A is able to detect if a person other than the customer assigned to the pick-up station accesses a purchase delivered to that pick-up station.

In addition, video data recorded by the video camera 214 monitoring a pick-up section 210A is helpful in resolving various customer relation issues, for example, when a customer claims that a certain product is not included in the purchase delivered to the pick-up section 210A assigned to that customer.

Also, the video cameras 214 may be assigned to the service and storage area 202 to record operations of a sales assistant that collects packages of an ordered purchase stored in different storage sections of the service and storage area 202, and places the collected purchase on the storage cart for delivering it to the assigned pick-up section 210A. The video cameras assigned to the service and storage area 202 are able to detect if a non-authorized person accesses any package in the service and storage area, and to detect if a sales assistant opens a package. As a result, the packages in the service and storage area 202 are prevented from being exposed to contamination by unwanted or dangerous substances.

In addition, the record produced by the video cameras 214 in the service and storage area 202 is helpful in resolving issues relating to damaged products delivered to the pick-up sections.

Further, the video cameras 214 may monitor the check out stations 208, service and storage area 202 and an entrance/exit area of the retail facility 12.

The tracking system 24 may contain a video monitoring data recording mechanism 112 (FIG. 2) for entering video data recorded by the video cameras 214 into the tracking system 24, and a video monitoring synchronization mechanism 114 for providing synchronization between recording performed by the package information recording mechanism 102 and video recording performed by the video monitoring data recording mechanism 112.

The synchronization mechanism 114 may provide association in time between the information identifying a current status and location of a particular package, and video data recorded by video cameras 214. For example, information on a position of the package in a particular time frame may be associated with video data obtained in that time frame. As a result, video data and package information relating to a particular time interval may be easily retrieved from the tracking system.

Further, the synchronization mechanism 114 may provide positional association between the information identifying a current status and location of a particular package, and video data recorded by video cameras 214, i.e. the location of the package may be associated with the location of the video camera 214.

In particular, information on a package delivered to a particular pick-up station may be associated with video data of a video camera 214 monitoring that pick-up station. Hence, video data relating to a particular package or a particular customer may be easily retrieved.

Also, information on a package located in the service and storage area 202 may be associated with video data of video cameras 214 monitoring the service and storage area 202.

The tracking system 24 may include look-up tables for providing time and positional association between the package information entered by the recording mechanism 102 and the video data entered by the video data recording mechanism 112.

To enable a customer to receive an ordered product without leaving a car, a retail facility 12 may be provided with a check-out parking facility containing multiple parking spaces sufficient to place a single vehicle. A parking space may be assigned to each customer arriving to receive an ordered purchase. As soon as a customer arrives, he or she is identified, and a parking space is assigned to enable the customer to pick up and inspect the purchase. At the same time, the purchase ordered by the customer is delivered to the parking space assigned to that customer. Such a retail facility is described in my copending U.S. patent application No. 09/840,070, filed on Apr. 24, 2001, entitled “RETAIL SYSTEM WITH DRIVE-THROUGH CHECK-OUT ARRANGEMENT” and incorporated herewith by reference.

The video cameras 214 of the video monitoring system 212 may be assigned to each parking space in order to monitor activities in connection with handling a purchase at the parking space. The synchronization mechanism 114 may provide association between information on a package delivered to a particular parking space, and video data of a video camera 214 monitoring that parking space.

Hence, the system for preventing unauthorized access to products of the present invention provides security measures to ensure that a product ordered by a customer is not exposed to contamination by unwanted or dangerous substances due to unauthorized access to the product.

Those skilled in the art will recognize that the present invention admits of a number of modifications, within the spirit and scope of the inventive concepts. For instance, the invention may be implemented in a number of different ways. For example, the tracking system, its various mechanisms, access control system and various security mechanisms may be implemented using specifically engineered chips having logic circuits and other components for performing the functions described above. Alternatively, these systems and mechanisms may be implemented using general purpose digital signal processors and appropriate programming.

While the foregoing has described what are considered to be preferred embodiments of the invention it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention.

What is claimed is:

1. A computer-implemented system for preventing unauthorized access to products in a retail system, comprising:
an order-processing system for receiving a purchase order from a customer, and
a tracking system for tracking a product ordered by the customer to prevent unauthorized access to the product.

2. The system of claim 1, wherein the retail system includes multiple retail facilities for enabling the customer to obtain the ordered product.

3. The system of claim 1, wherein the tracking system is configured for tracking food products ordered by the customer.

4. The system of claim 1, wherein at least one separate package is provided for packing the product ordered by the customer.

5. The system of claim 4, wherein the package is sealed to prevent exposure of the product to contamination.

6. The system of claim 4, wherein the tracking system is configured to record information indicating location of the package until the customer receives the ordered product, to prevent the package from being placed in an unauthorized location.

7. The system of claim 6, wherein the tracking system comprises a misplacement alarm mechanism for indicating that the package is located outside of a predetermined route from a package packing location to a destination location requested by the customer.

8. The system of claim 4, wherein the tracking system is configured to record information on every person handling the package to prevent unauthorized access to the package.

9. The system of claim 4, wherein the tracking system comprises a personnel verification mechanism for determining whether the package is being accessed by an authorized person.

10. The system of claim 4, wherein the tracking system comprises an unauthorized access alarm mechanism for indicating that an unauthorized person has access to the package.

11. The system of claim 4, wherein the purchase order is transferred to a storage facility for preparing the package with the ordered product.

12. The system of claim 11, wherein an ID information on the package prepared on the storage facility is entered into the tracking system.

13. The system of claim 12, wherein the ID information on the package identifies a destination for delivery of the package.

14. The system of claim 11, the tracking system is configured to maintain a package address data stream indicating changes in location of the package formed in the storage facility until the packet is received by the customer.

15. The system of claim 11, wherein the storage facility is provided with a security mechanism for preventing unauthorized access to the storage facility.

16. The system of claim 11, wherein the tracking system is configured for recording transportation information for the package to identify a transportation unit for delivery of the package to a destination requested by the customer.

17. The system of claim 16, wherein the tracking system comprises a transportation verification mechanism for determining whether the package is being delivered by an authorized transportation unit.

18. The system of claim 16, further comprising a security mechanism for preventing unauthorized access to the transportation unit.

19. The system of claim 4, wherein the package is delivered to a retail facility for enabling the customer to receive the ordered product.

20. The system of claim 19, wherein the retail facility is provided with an access control system for controlling access to the retail facility.

21. The system of claim 20, wherein the access control system is configured to identify customers entering the retail facility.

22. The system of claim 21, wherein the retail facility includes multiple purchase pick-up points for enabling the customers to receive and inspect ordered products.

23. The system of claim 22, wherein the access control system is configured to enable the customer to access the retail facility only after a purchase pick-up point is assigned to the customer.

24. The system of claim 22, wherein the retail facility has a storage area for temporary storage of the package delivered by the transportation unit until the customer arrives to pick up the ordered product.

25. The system of claim 24, wherein the storage area is provided with a security mechanism for preventing unauthorized access to the storage area.

26. The system of claim 24, wherein the tracking system is configured for recording information indicating that the package is placed in the storage area.

27. The system of claim 26, wherein the tracking system is configured for recording information indicating that the package is delivered to a purchase pickup point assigned to the customer that ordered the product contained in the package.

28. The system of claim 27, wherein address information of the package in the tracking system is updated when the package is placed on a storage cart for delivery the package from the storage area to the assigned purchase pick-up point.

29. The system of claim 28, wherein the address information of the package in the tracking system is updated when the package is removed from the storage cart and placed at the assigned pick-up point.

30. The system of claim 22, wherein the retail facility is provided with a video monitoring system comprising a plurality of video cameras for producing video data relating to handling the package.

31. The system of claim 30, wherein the tracking system comprises video synchronizing system for synchronizing package tracking data recorded by the tracking system with the video data produced by the video monitoring system.

32. The system of claim 31, wherein the video synchronizing system is configured to create association between the package tracking data recorded during a particular time frame and the video data recorded during that time frame.

33. The system of claim 31, wherein the video synchronizing system is configured to create association between location of a video camera that produces the video data and location of the package identified by the package tracking data recorded by the tracking system.

34. The system of claim 31, wherein a video camera is assigned to each purchase pick-up point.

35. The system of claim 34, wherein the video synchronizing system is configured to provide association between the package tracking data relating to the package delivered to a purchase pick-up point assigned to the customer that ordered the product contained in the package, and the video data produced by the video camera assigned to that purchase pick-up point.

36. The system of claim 35, wherein the purchase pick-up point enables the customer to receive the package without leaving a vehicle.

37. A facility for selling goods, comprising:
a plurality of purchase obtaining points for enabling customers to purchase required products,
a plurality of monitoring devices for monitoring operations in connection with handling the products, at least one of the monitoring devices being assigned to a purchase obtaining point of the plurality of the purchase obtaining points, and
a computer system for recording data for tracking products purchased at each of the purchase obtaining points, the computer system including a mechanism for creating association between the data recorded at a particular purchase obtaining point and video information recorded by a monitoring device assigned to that purchase obtaining point.

38. The facility of claim 37, wherein the computer system further including a mechanism for creating association between the data recorded during a particular time frame and video information obtained by the monitoring device during that time frame.

39. The facility of claim 37, wherein the required products are pre-ordered in advance.

40. The facility of claim 37, wherein each of the purchase obtaining points includes a section for inspecting the pre-ordered products delivered to the section.

41. The facility of claim 37, wherein the products include food products.

42. The facility of claim 37, further comprises an access control system for controlling access of the customers to the facility.

43. The facility of claim 42, wherein the access control system is configured to enable a customer to access the facility only after a purchase obtaining point is assigned to the customer.

44. The facility of claim 43, wherein a product ordered by the customer is delivered to the purchase obtaining point assigned to the customer.

45. The facility of claim 37, further comprising an area for storing delivered products.

46. The facility of claim 45, wherein at least one of the monitoring devices is assigned to the area for storing delivered products to record video information in connection with handling the delivered products in the area for storing delivered products.

47. The facility of claim 46, wherein the computer system is configured for recording position data indicating location of each package of the delivered products in the area for storing delivered products.

48. The facility of claim 47, wherein the computer system includes a mechanism for creating association between the position data relating to packages located in the area for storing delivered products and the video information produced by the monitoring device assigned to the area for storing delivered products.

49. A computer-implemented method of selling goods comprising the steps of:
enabling a customer to order a product in advance,
forming a package including the ordered product, and
tracking the package until the product is received by the customer to prevent unauthorized access to the product.

50. The method of claim 49, wherein the product is received at a retail facility.

51. The method of claim 50, including the step of identifying a customer arriving at the retail facility to pick up the ordered product.

52. The method of claim 51, wherein the retail facility comprises multiple purchase pick-up points.

53. The method of claim 52, wherein the customer is allowed to access the retail facility only when a particular purchase pick-up point is assigned to the customer.

54. The method of claim 53, wherein the product ordered by the customer is transferred to the purchase pick-up point assigned to the customer.

55. A computer-implemented method of selling goods comprising the steps of:
providing multiple purchase pick-up points for enabling customers to receive the goods,
recording information identifying the goods to be received by the customers,
monitoring the purchase pick-up points to record video data, and
providing association between the recorded information on a product received at a purchase pick-up point, and the video data relating to that purchase pick-up point.

56. The method of claim 55, wherein a customer is assigned to a purchase pick up point.

57. The method of claim 56, wherein a product ordered by the customer is delivered to the purchase pick-up point assigned to that customer.
